(19) United States
(12) Patent Application Publication
(10) Pub. No.: US 2014/0334249 A1
(43) Pub. Date: Nov. 13, 2014

(54) BEVERAGE MIXING, STORING AND DISPENSING APPARATUS

(71) Applicant: Roxi Group, Inc., Reno, NV (US)

(72) Inventor: Marc Radow, Reno, NV (US)

(21) Appl. No.: 13/889,923

(22) Filed: May 8, 2013

(51) Int. Cl. B01F 13/08

(52) U.S. Cl. CPC B01F 13/0845
USPC 366/273

(57) ABSTRACT

A magnetic beverage dispenser and mixer apparatus including a container and a magnetic motor to drive a stir bar in the container. The stir bar is rotated by an external magnetic drive motor to stir the liquid in the container. The container includes a bottom base which may have a mechanical retainer that retains the magnetic stir bar in the base in an operative rotating position relative to the motor to provide stirring access of the stir bar to liquid in the container. The container can have a spigot for dispensing the liquid. The base portion can be shaped to effect/enhance the mixing/tornado action of the liquid. A controller can control the motor using information from the user and/or information concerning properties/conditions of the fluid and/or the stir bar detected by sensors.

### BACKGROUND

The present disclosure relates to apparatus that can be used to mix, store and dispense consumable beverages.

### SUMMARY

The present inventions can employ the technology of using a rotating magnetic field to spin a magnetic stir bar immersed in a liquid in a container and thereby mixing the liquid. The rotating field can be created by a rotating magnet or a set of stationary electromagnets, positioned beneath and external to the container. The magnetic stir bars can be permanent or semi-permanent magnet bars covered with an inert layer of TEFLON, glass or the like to provide for sterile conditions (removable for a semi-permanent configuration).

Magnetic stir bars or magnetic mixers are often used in pharmaceutical or industrial environments where leakage and contamination is a concern. Since bearings, seals or openings are not needed to drive the magnetic bars in magnetic stir bars/mixers, the likelihood of leakage or contamination is reduced if not eliminated. The liquid is typically mixed in a beaker, flask or test tube. Examples of laboratory magnetic mixers are the Model CJI mixer available from the Minhua Pharmaceutical Machinery Co., Limited, the HI 1 90M-1 Magnetic Stir bar available from the Hanna Instruments Company and various other mixers available from Thermo Scientific Company.

These magnetic stir bars suffer from shimmering and/or skipping of the stir bar. “Shimmering” is when the stir bar will not spin in the desired direction, which is the direction of the magnets or of the magnetic charge from the coils; rather, the stir bar starts to move in that direction but fails to move a sufficient distance and the magnetic attraction of the motor then moves to the next and subsequent positions, exerting a force then in the direction opposite to the desired direction of the magnetic stir bar. Then the direction of the magnets or the direction of the magnetic charge of the coils moves further and then attracts the stir bar in the desired direction but again fails to move sufficiently in that direction, causing a continuous loop “shimmering.” The “shimmering” motion can also be described as a vibrating motion.

“Skipping” is similar to shimmering in that it can result from the rotational speed of the stir bar being slower or faster than that of the drive motor. It differs in that the stir bar jumps over itself, end over end. This is caused by the power of the magnetic force being great enough to flip the stir bar end over end and the coincidental positioning of the magnetic stir bar and the magnets of the motor to be just right to make the stir bar jump.

In other words, the operation of the magnetic mixer is affected by the polarization of magnets in the motor opposite the polarization of the magnet in the stir bar. As these opposite polarizations attract and the stir bar rotates toward the correct motor polarization, the motor quickly then “leads” the polarization of the stir bar in a circular fashion. Executed quickly enough the stir bar rotates quickly to agitate/turn the liquid often in a vortex or tornado like action. However, if the motor moves too quickly ahead of the stir bar (due to any of the elements restricting/slowing the movement of the stir bar) the magnets of the motor will instantly and momentarily cause the stir bar to change direction, thereby causing the stir bar to skip.

Thereby, the magnetic stir bars in the containers can slip off center during operation, requiring the mixer to be stopped and the magnetic stir bar manually repositioned. In fact, the magnetic bars of laboratory/pharmaceutical mixers are sometimes called “fleas” because of the way they jump about if the rotating magnet is driven too fast.

The present inventor has discovered that shimmering can be avoided or stopped by increasing the magnetic force of the drive motor on the stir bar to move the stir bar to the desired position and/or by slowing the motor to allow more time for the stir bar to move to the desired position. It may be that slowing the motor alone may not move the stir bar at all in which case the magnetic force of the drive motor may have to be increased.

Movement and position of the stir bar, such as whether the stir bar is moving with or on the verge of moving with a shimmering movement or a skipping movement, can be detected by an optical, electronic or magnetic reader or sensor of an exemplary apparatus of this disclosure. This reader or sensor transmits one or more signals as to the movement and/or position to the controller or CPU, which then sends control signals to the motor to remedy or prevent the problem. Alternatively, the reader or sensor can send a signal to a user, such as a visual or audible alarm, and the user can cause the controller, such as by flipping a switch, to send the control signals. A further alternative is to not have any reader or sensor, but rather to rely on the user when he detects undesirable stir bar motion and/or position to signal the controller to send the control signals to the drive motor.

The present inventor has discovered that this slipping and repositioning would be unsightly, inconvenient and otherwise unacceptable if the magnetic stir bar technology were used in the residential or commercial beverage storage, mixing and dispensing environment. Accordingly, the present inventor has invented various retaining systems for retaining the stir bar in an operative stirring position in the liquid container while still providing mixing access of the stir bar to the liquid in the container. A number of different retaining system embodiments are disclosed herein. They can be mechanical retainers that physically restrain movement of the mechanical stir bar in the container. This can be in lieu of or in addition to controlling the speed of magnetic drive motor to prevent or stop shimmering and/or skipping.

An exemplary beverage mixing, storing and dispensing apparatus can include a liquid container, which can be a relatively rigid container having a volume of between one and thirty liters. The container can be free of any internal bag for holding the liquid. The container can have a removable lid, covering an opening through which the container can be filled with the beverage or the beverage components. It can have a spigot for dispensing the mixed beverage into awaiting glasses, cups or other drinkware.

Examples of beverages which can be mixed, stored and dispensed by apparatus of the present disclosure include juices, colored and flavored waters, spirits, cocktails, teas, coffees and the like. Further, a dry mix or a liquid concentrate can be added to water in the container. The dry mix can be a flavored and/or colored beverage mix or powder, and different flavors and/or types include apple, pineapple, blackberry, raspberry, coconut, strawberry, coffee, tea, lemonade and chocolate. The mixing action of the stir bar causes the dry mix or liquid concentrate to disperse in the water and then prevents the undissolved particles from settling.

The present apparatus may have a number of advantages over prior art commercially available beverage “mixers.” These advantages may include lower cost, low level agitation of the beverage over extended periods of time, convenient and low cost installation, ease of display and consumer viewing of the beverage, sanitary operation and ease of cleaning.

As the magnetic stir bar rotates or spins in the beverage container it can cause a vortex or small mixing “tornado” in the container. With a transparent or partially transparent container, this tornado can be interesting or appealing to those nearby, particularly where the beverage is colored, multi-colored and/or contains particulate matter. For example, if the mixer apparatus is being used in a bar by a bartender or waiter the tornado effect can be a desirable talking point to customers sitting or standing nearby and an advertisement for the beverage being mixed. Different constructions of the containers, retainers, bottom bases and/or stir bars pursuant to one or more of the apparatus inventions herein and/or different methods pursuant to one or more of the operation method inventions herein can vary this tornado effect thereby having a desirable effect on the mixing action and/or presenting a visually appealing variable and/or alternative tornado effects.

An example of a beverage mixing, storing and dispensing apparatus of the present invention includes a relatively powerful magnetic mixer drive motor that uses, for example, a rotating permanent magnet or stationary electromagnets to rotate a magnetic stir bar or magnetic stir bar in beverage liquid in a closed container. The stir bar can be a relatively weakly magnetized, disposable stir bar and for example, can be a stir bar molded entirely of non-isotropic ferrite.

Magnetic coils or electromagnets with alternately rotating magnetic fields avoid the use of rotatable parts, thereby reducing wear and maintenance and improves sanitation and speed to clean and refill the beverage and/or the beverage components. The container can be a generally rigid container, free of any flexible bags to contain the liquid, and can have a top lid and a spigot positioned either near the base or through a pumping mechanism located a distance up from the base of the container to facilitate filling drinkware beneath the spigot. The container can be positioned so that the stir bar is in a proximate, operative position relative to the drive motor by structure which is part of the motor assembly or by structure which is separate from the motor assembly.

The apparatus can have a retaining means for retaining the stir bar in an operative position relative to the drive motor and for preventing it from skipping out of position in the container. The retaining means can be mechanical means such as some type of physical restraint attached to or part of the bottom base of the container. Examples thereof include recessed retaining areas with perforated retainers, a cage mounted on the floor of the base or an upright pin pass through the stir bar and about which the stir bar rotates. Alternatively, the retaining means can be some type of control means for controlling the speed of the motor relative to that of the stir bar or the power of the motor.

The apparatus can have a contoured base for retaining the stir bar in an operative position relative to the drive motor and centrally within and/or at the base of the container preventing it from slipping to a peripheral position of the container and out of position relative to the drive motor. These and other examples are set forth more fully below in conjunction with drawings, brief descriptions of which follow.

### BRIEF DESCRIPTION OF THE DRAWINGS

FIG. A is an exploded perspective view of an exemplary beverage mixing, storing and dispensing apparatus.

FIG. B is an enlarged perspective view of a first alternative magnetic stir bar.

FIG. C is a view similar to FIG. B of a second alternative magnetic stir bar.

FIG. D is a top plan view of a first alternative bottom base.

FIG. E is a cross-sectional view taken on line E-E of FIG. D.

FIG. F is a view similar to FIG. E of a second alternative bottom base.

FIG. G is a view similar to FIG. D of a third alternative bottom base.

FIG. H is a cross-sectional view taken on line H-H of FIG. G.

FIG. I is a view similar to FIG. D of a fourth alternative bottom base.

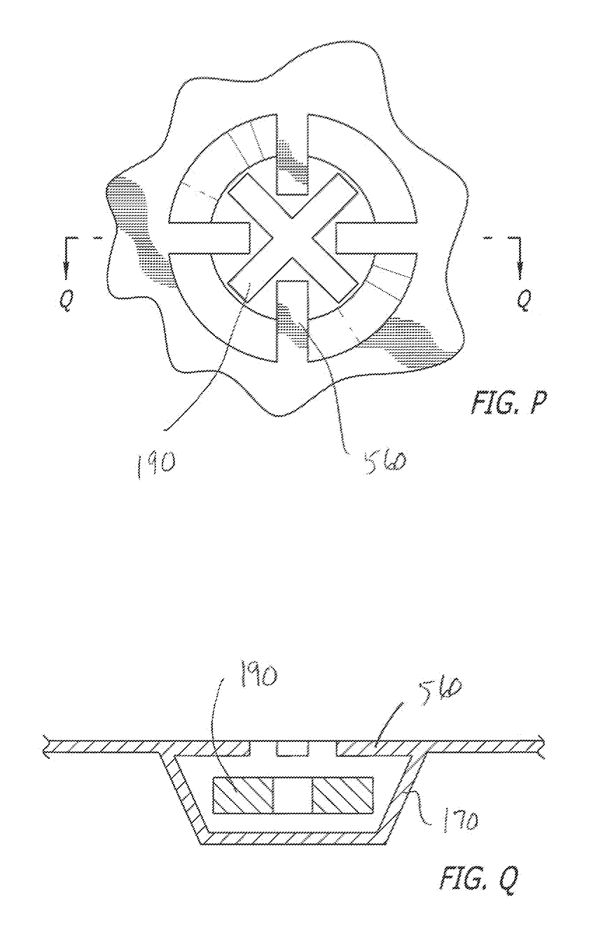

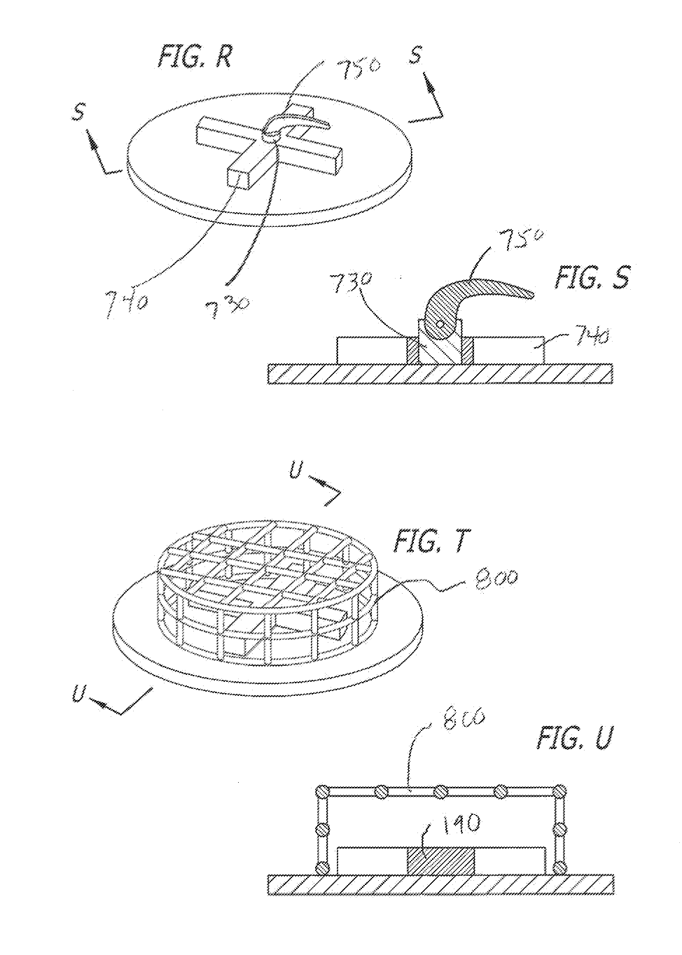

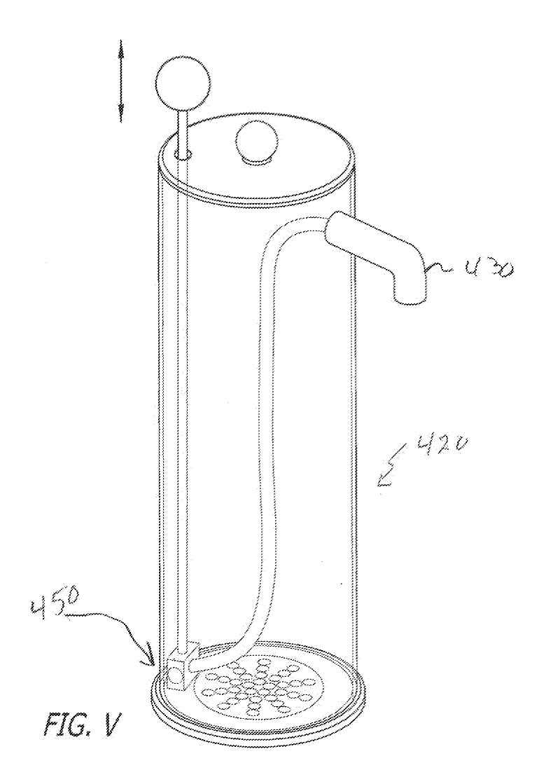

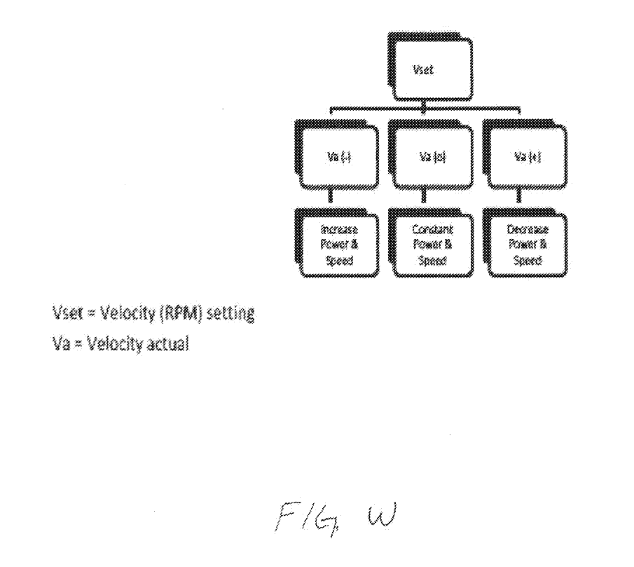

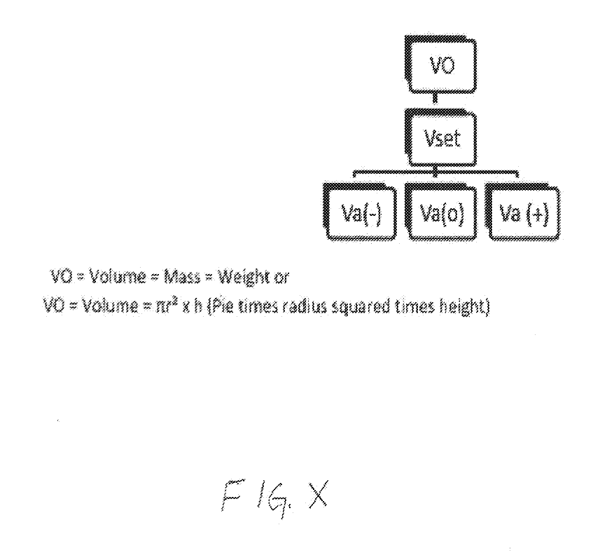

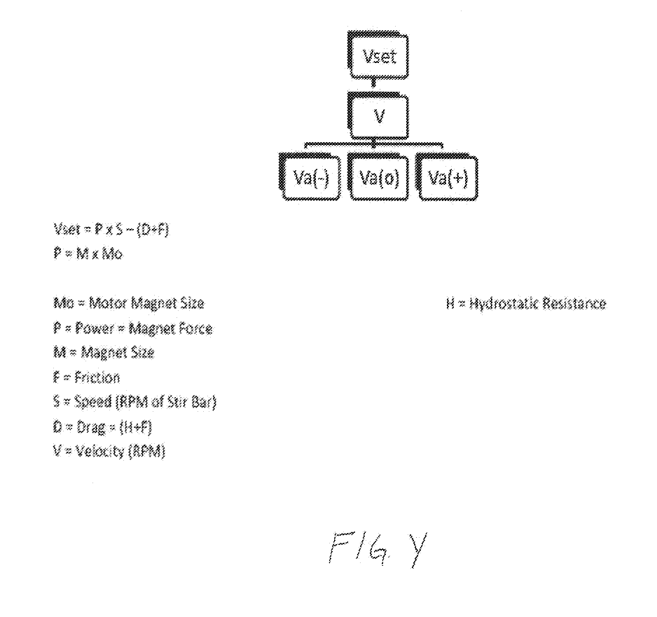

FIG. J is a view taken on line J-J of FIG. 1.

FIG. K is a view similar to FIG. D of a fifth alternative bottom base.

FIG. L is a top plan view of a first alternative retainer.

FIG. M is a view similar to FIG. L of a second alternative retainer.

FIG. N is an exploded perspective view of an alternative beverage mixing, storing and dispensing apparatus.

FIG. O is an enlarged cross-sectional view of a bottom portion of the apparatus of FIG. N in a mixing operation and with the internal motor components omitted for ease of illustration.

FIG. P is a top plan view of an alternative retainer construction for retaining a stir bar in a recessed area of a bottom base.

FIG. Q is a cross-sectional view taken on line Q-Q of FIG. P.

FIG. R is a perspective view of an alternative bottom base having a pivot pin about which the stir bar can spin and a retainer at the top of the pin for releasably maintaining the stir bar on the pin.

FIG. S is an enlarged cross-sectional view taken on line S-S of FIG. R.

FIG. T is a perspective view of an alternative bottom base having a cage for retaining the rotatable stir bar in place.

FIG. U is an enlarged cross-sectional view taken on line U-U of FIG. T.

FIG. V is a perspective view of an alternative container for the apparatus of FIGS. A and N and having an upper spigot and a pump for pumping beverage from a bottom of the container up to the spigot for dispensing the beverage.

FIG. W is a chart showing a first way of controlling the speed of the motor.

FIG. X is a chart showing a second way of controlling the speed of the motor.

FIG. Y is a chart showing a third way of controlling the speed of the motor.

### DETAILED DESCRIPTION OF EXEMPLARY EMBODIMENTS

This specification taken in conjunction with the drawings sets forth examples of apparatus and methods incorporating one or more aspects of the present inventions in such a manner that any person skilled in the art can make and use the inventions. The examples provide the best mode(s) contemplated for carrying out the inventions, although it should be understood that various modifications can be accomplished within the parameters of the present inventions.

### Overall Apparatus

Referring to FIG. A, an exemplary apparatus is illustrated generally at 100. Apparatus 100 includes a beverage mixing, storing and dispenser container 110. Container 110 can include a base 120, a side wall 130, a spigot 140 and a lid 150 having a handle 160. The lid can have a simple friction fit in the top opening of the container. The friction fit can be overcome by pulling up on the knob. The base 120 can include a recessed area 170 surrounded by a ring 180. A magnetic bar or magnetic stir bar 190 is shown in FIG. 1 in exploded relation relative to the recessed area 170. A retainer 194 can be positioned on the base 120 over the recessed area to keep the magnetic stir bar 190 in the recessed area. The retainer 190 can include openings 200 to allow the liquid/fluid 210 in the container 110 to freely communicate with the magnetic stir bar 190 for mixing action.

The container 110 can be positioned directly above a magnetic drive motor 210 such that the bottom of the recessed area 170 rests on the top of the magnetic drive motor at the operative place on the drive motor to provide delivery of strong magnetic spinning power to the magnetic stir bar 190.

### Motor

The driver can be a Thermo Scientific VARIOMAG Mono Direct motor. Instead of electric motors spinning permanent magnets this motor has stationary magnetic coils through which current is varied. It is powered by at least one or more power sources, one of which is an AC 230 Volt input. A rotating magnetic field is thereby produced to drive the magnetic stir bar at a speed of 130-1000 rpm. A recommended stirring volume is up to 3,000 mL (but more can be effectively stirred depending on an array of variables such as viscosity of the liquid and amount of stirring action desired). The motor can have a rotary knob that controls the basic stirring tasks. The driver can have a minimum speed range of 90-120 rpm and a maximum speed range of 900-1200 rpm.

The magnetic stir bar can be rotated at a speed of between two hundred and one thousand rpm. The speed can vary depending on, for example, the viscosity of the liquid, the amount of liquid, the shape of the stir bar and the size of the stir bar.

### Holder for Container

The container 110 can be held in upright position over the drive motor 210 by a cover 220. Cover 220 includes side walls 230, a top plate 240 having a through-hole 250, and a top panel 260 having holes 270, 280, which provide access to motor controls 290, 300 when the cover 220 is positioned over the drive motor 210. The through-hole 250 holds the container sidewall in a desired position on the motor. The through-hole 250 acts as a holder sleeve for the container and is shaped similar to a cross-section of the container. An alternative holder for the container 110 over the drive motor 210 can be simply a sleeve held in position above the drive motor 210 by legs straddling the drive motor. This alternative would not shield the drive motor from liquids like the cover 220 does.

More particularly, the base of the container can be fitted into a base cover which covers, protects and houses the magnetic motor device. The base can have a hole in a top surface thereof that positions the tube into the base cover and onto the magnetic motor. More particularly, the bottom base can be merely set on top of the motor and inside of the hole. The cover can is completely house the magnetic motor, but have openings to allow access and viewing of the motor controls, such as the on/off switch and the power light. The cover can protect any electronics inside of the motor/driver. The stir bar remains in close proximity to the magnets in the motor.

Alternatively, the “cover” and the motor can be constructed to be a single unit with the cover and motor affixed or removably attachable to one another. The cover can be constructed to protect the motor and/or to correctly position the container (or more particularly the stir bar) relative to the motor. The cover can have a hole, opening or recessed area to receive the bottom end of the container.

The cover can be configured as a holder that holds the container upright and in an operative position relative to the motor. The stand can have legs which straddle the motor or can be mounted and supported by the motor. The holder can be attached to the motor.

The holder can simply position the container relative to the motor with the container being supported by the motor or the holder can also hold the container. A portion of the holder can be configured to act as a cover for the magnetic driver motor to protect it from liquids from the surrounding environment and/or the container.

An alternative cover-drive motor assembly is illustrated in FIG. N wherein the apparatus 250 includes a drive motor 260 having a container holder 270 integrally formed as a part of the casing of the drive motor. It is depicted as recessed area on the top surface. An alternative configuration would be for the holder to be a sleeve extending up from the top surface. The container 280 of apparatus 250 can be similar to that of FIG. A. It can include a sidewall 290, a lid 300 with knob handle 310, a spigot 320, and a base 330. Base 330 includes a recessed area 340 and a surround ring 350 having a circular recessed area 360 surrounding the recessed area. The circular recessed area 360 can receive the outer perimeter area of the retainer plate 370. Retainer plate 370 has an alternative pattern of through holes 380, different from those of plate 190. Plates 370 and 190 are interchangeable and other plate configurations are described later. Similarly, the shape of magnetic stir bar 390 is different from that of FIG. A. They can be interchangeable and other stir bar configurations are described later.

FIG. O is an enlarged cross-sectional view of the lower portion of the apparatus of FIG. N, showing the apparatus assembled and operating with a beverage in the container being mixed and thereby causing a tornado, vortex or agitation 400 to be formed. While the casing and a control knob for the motor are illustrated, the motor itself has been omitted for illustrative purposes.

### Spigot

A further alternative container of the disclosure is illustrated in FIG. V by reference numeral 420. The motor and cover/container support are not shown. In contrast to the containers of FIGS. A and N, the container 420 of FIG. V has its spigot 430 positioned at an upper location of the container. This position can be used when it is advantageous to locate the spigot in a higher vertical location to provide clearance for drinkware beneath the spigot. Instead of gravity feeding the beverage to the spigot, a pump 450 can be used to pump the beverage from a lower location in the container up a tube to the spigot.

### Container

The container or container can be a sealed “tube.” The base of the container or container can be a base having a recessed area and the base can be sealed to the bottom of the container, such as by gluing or welding. The “tube” and base portions along with other features of the container can be constructed in either a singular mold or in a family of molds, for example. A spout or spigot on the container and near the base allows a user to withdraw via gravity a quantity of the liquid in the container.

The container can be generally any shape with cylindrical being one of the preferred shapes. The cylinder can have generally any cross-sectional shape, such as a circle, hexagon, rectangle or oval. For example, it can have an hourglass shape, a bulbous shape, a frusto-conical shape or a shape where its longitudinal axis is non-linear, e.g., curving. It can be a combination of shapes, such as a torus on top of a cylinder. Its shape can be chosen to improve the mixing effect, to provide for an interesting tornadic effect as the mixing starts and/or to be aesthetically intriguing. Its shape can be distinctively associated with the commercial user's trademark or with the beverage to be mixed.

The container can have a reverse hourglass shape (wider in the middle than at the top and bottom). It can have a shape resembling an object, such as a beer bottle or martini glass, or a symbol, such as the Nike Swoosh or a college team symbol. While these different shapes may reduce the compactness of the apparatus, they can have aesthetic and/or advertising appeal.

The container can be made of any suitable material, typically a rigid material. Plastics, such as clear acrylic, can be used particularly where the beverage contents are to be viewed.

### Stir Bar

A one inch (plus or minus approximately one-half inch) “plus” (+) shaped stir bar can be used in a container which is six inches in diameter and eighteen inches tall and thus having a volume of generally seven liters when filled to near the top of the container. However, it may be desirable to change the size (and/or shape) of the stir bar for containers having different sizes and/or shapes.

The stir bar can have a cross, T or “plus” sign (-′-) shape. It can have dimensions of approximately one inch, or a range of three-quarter inch to one and-a-half inches, in a container with the above dimensions. The stir bar alternatively can have a square, round, tapered, egg shaped, star shaped or disk shaped configuration. The stir bar can have a flat portion with one or more stirring wings or tabs extending upwardly from the flat portion.

Another configuration can be a waving pattern with flairs, such as on a propeller, to accentuate the tornado effect. A stir bar 500 that is “dome” or semispherical on the underside and ‘+’ shaped on the top (FIG. B) or a waving pattern 520 with flairs (FIG. C) (such as on a propeller) on the top to accentuate the tornado effect would be effective. The semispherical shape on the underside (which can have a small ‘flat’ portion to better balance this stir bar so that it point directly upward) can 25 reduce rotational friction against the base (verse the standard ‘+’). A sculptured ‘+’ or waved pattern can augment the hydrodynamic tornado effect.

The size of the stir bar can change as the diameter and height of the container change. As an example where the container or container is eighteen inches tall and six inches in diameter and has a volume of approximately seven liters, a one inch “plus” shape bar can be used. The stir bar can be dome or semi-spherically shaped on the underside with a “+” shape on the top. The semispherical shape on the underside, which can have a small ‘flat’ portion to better balance this stir bar so that it points directly upward, may reduce rotational friction against the base experienced by a simple plus shape stir bar. A sculptured “+” or waved pattern may augment the hydrodynamic tornado effect.

### Retainer

A retention plate can be a “mesh” (FIG. M) 540 or “grid” that fits over the stir bar over the recessed area in the base of the container. The base can be connected to the base at the higher elevation of the base, spanning across the recessed area.

For example, a mesh size (the size of the holes in the mesh) can be a sieve equal to or larger than: sieve designation standard 4.75 mm; sieve designation alternate “mesh” No. 4; nominal sieve opening 0.187 inch; and nominal wire diameter 1.6 mm. The mesh size can be adjusted for both the viscosity of the liquid and the size of the stir bar.

The mixer can be constructed to reduce the likelihood or even prevent the stir bar from leaving the recessed area during operation or use of the mixer but still allowing good access or mixing contact of the stir bar with the liquid (beverage) in the container. This can be done by constructing the recessed area with an upper bulging or protruding members (see FIGS. P and Q at 560), which can be continuous or intermittent. It can be configured to allow removal of the stir bar from the recessed area when the stir bar is at a specific angle(s) relative to the bulging area.

For example, the stir bar may need to be aligned with the bulging area and then twisted to remove it. Another construction to keep the stir bar in the recessed area without significantly reducing the stirring effect is to provide a retainer. An example of a retainer is a perforated base or a grate positioned over the opening into the recessed area. The base or grate can be similar to a shower drain. The perforations can take generally any pattern, and the pattern may be selected to improve the mixing action and/or the tornadic effect. The base or grill can be exchanged for a differently configured one, for example where a beverage having different physical properties (e.g., thicker or thinner) is to be mixed in the container and/or a different tornadic effect is desired.

For example, the perforations can be in an x-y grid arrangement, a concentric circular arrangement or an outwardly swirling pattern. The perforations or openings can all be the same size and/or shape or some/all can be different sizes or shapes. The ‘base” can be simply a grid of rods, and for this construction the perimeter of the bottom base surrounding the opening of the recessed area can include spaced recesses extending radially out from the recessed area, each to receive an end of a respective rod of the grid of rods.

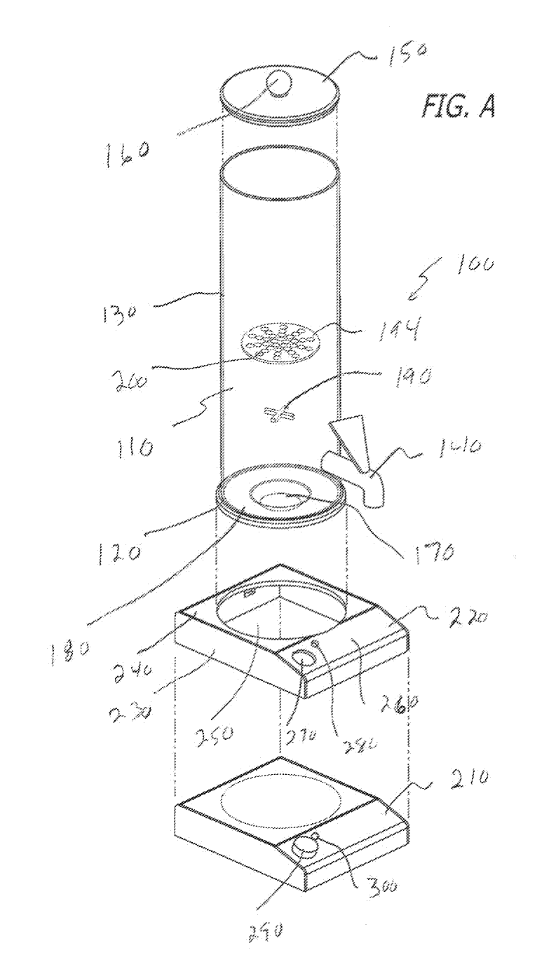

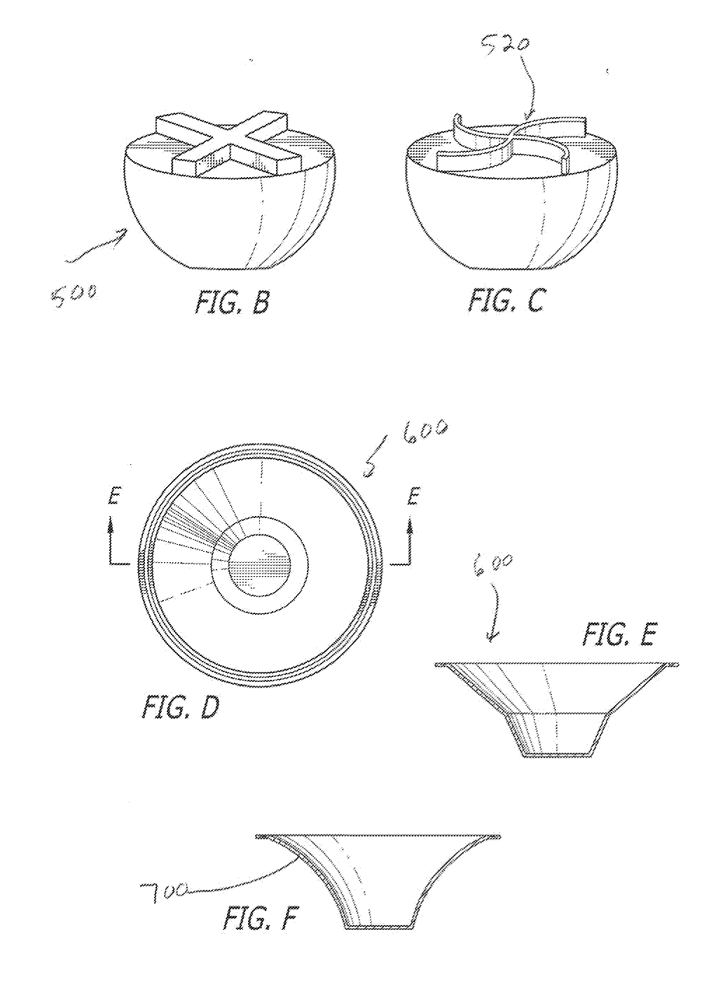

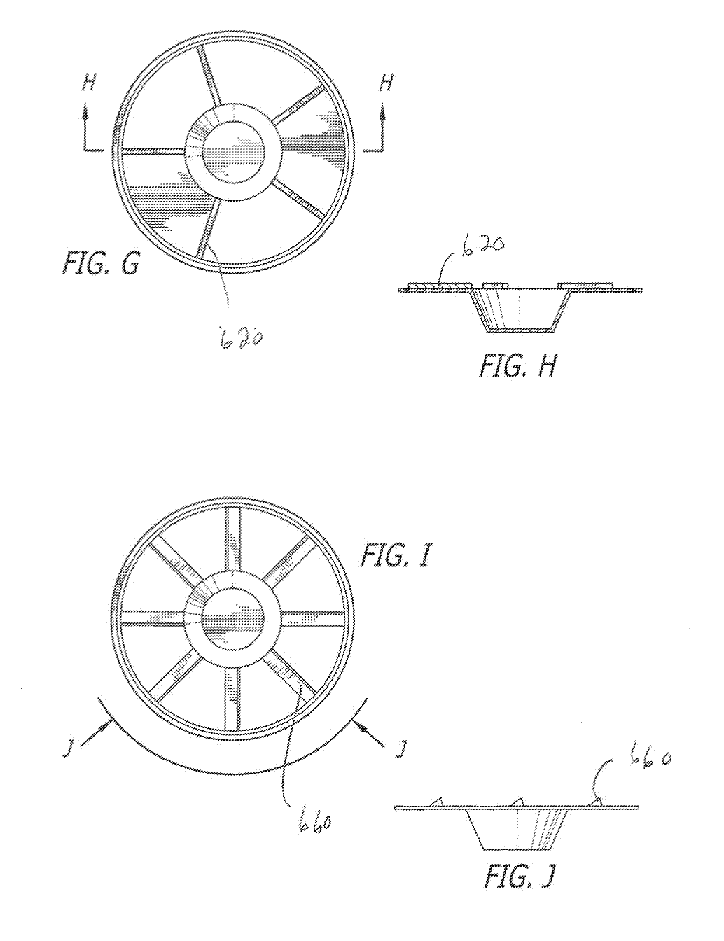

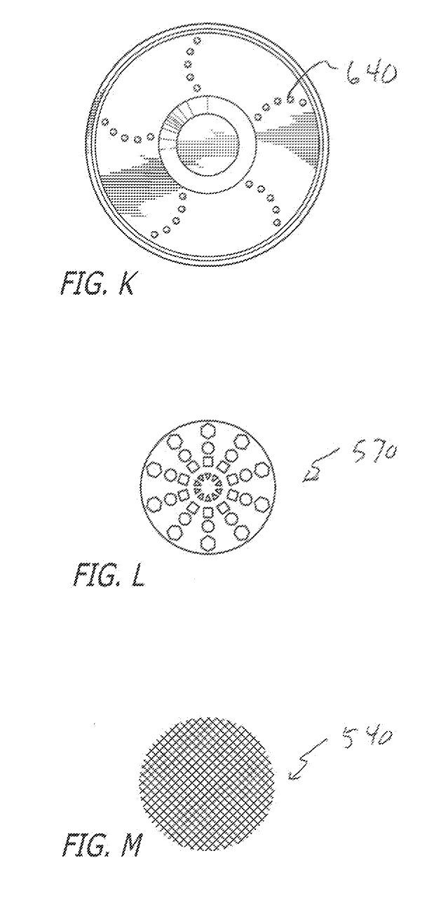

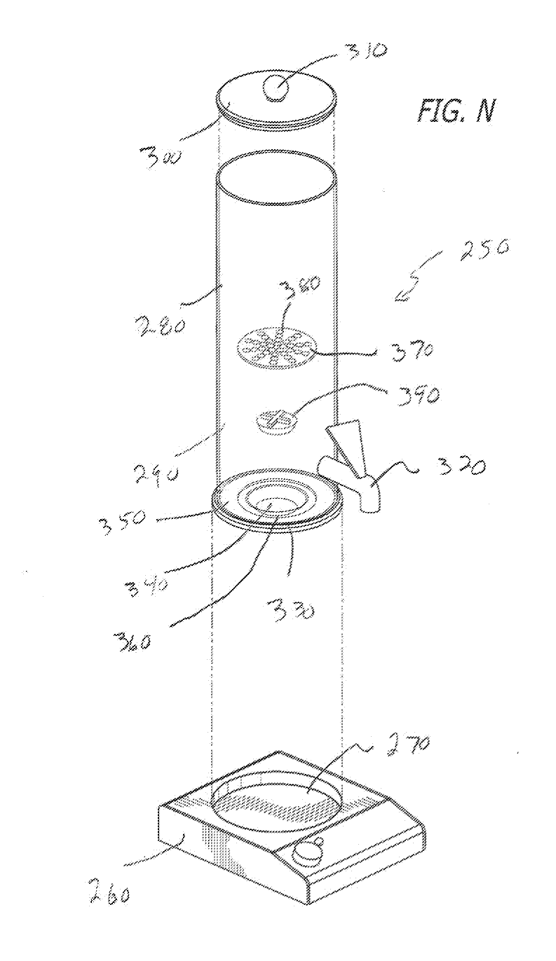

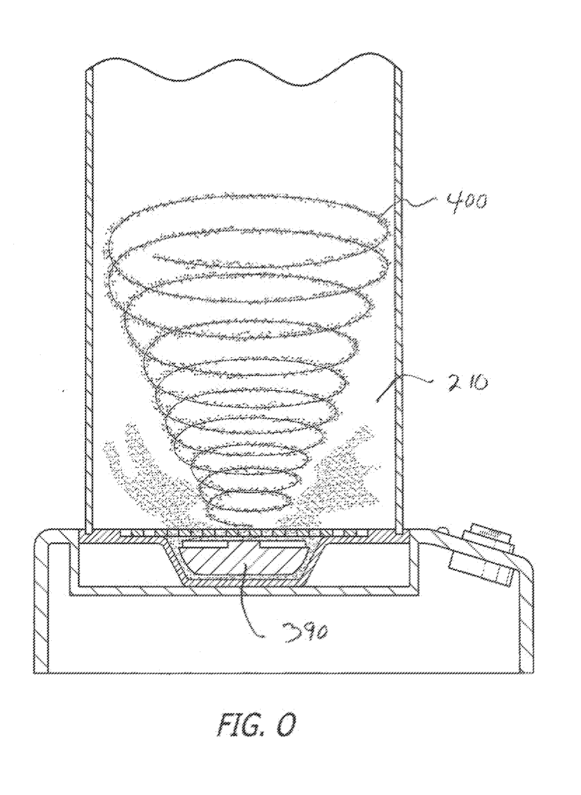

The retention plate 570 (FIG. L) or grate can be positioned over the opening of the recessed area in which the magnetic stir bar is positioned. (See FIG. 0, for example.) It can be positioned in a recessed area. It can be attached to the bottom base, preferably releasably attached. As the magnetic stir bar turns, it will spin or agitate the liquid passing through the retention plate or grate. If the magnetic stir bar skips, such as due to the motor “spinning” too quickly for the magnetic stir bar, the base or grate will prevent the stir bar from skipping out of the recessed area.

The retention plate can have any number of grid designs that allow the liquid to easily pass through. The grid openings are small enough to retain the stir bar. The openings in the retention plate can all be the same size or can be different sizes, can all be the same shape or different shapes, and can be arranged in various patterns. (See and compare FIGS. A, L, N and V) Instead of a grid of connected rods, the “retainer” can be one or more individual rods or wires.

If the retainer has a base shape, then the surrounding area can include a perimeter recess for receiving and positioning the retainer. The retainer can simply rest on the bottom base or can be removably attached to the bottom base such as by a snap-in means. Another attachment means can be a peg-and-groove arrangement where one of the retainer and the base has a peg and the other has an arcuate groove and the user twists the retainer such that the peg fixes in the groove. Further, the retention plate can be effective to keep the stir bar in the recessed area when the apparatus is not operating and the user is filling or adding contents to the container.

Thus, as the stir bar turns, it will spin or agitate the liquid passing through the retainer. However, if the stir bar “skips,” for example because the motor is spinning too quickly for the stir bar, the retainer will block the stir bar from skipping out of the recessed area and retain it in an operative stirring position.

That is, the retention plate can have any number of “grid” designs that both allow the liquid to pass through while retaining the stir bar.

### Base and Ring

The base can be made of any suitable material such as plastic, steel and glass, and an exemplary material is acrylic.

The ring portion can be flat, such as illustrated in FIG. A. Alternatively, the ring portion can slope towards the center portion, such as illustrated in FIGS. D and E at 600. The ring portion can be smooth or it can include projections and/or recesses (see FIGS. G, H, I, J and K). The projections and/or recesses can be provided to improve, change or otherwise effect the stirring action of the liquid by the stir bar. They can be provided to change the tornado effect or action of the liquid, caused the rotating stir bar. This can be done to change the stirring action or for aesthetic reasons. One example is to have the projections and/or recesses 620 (FIGS. G and H) extend radially out from the center portion, either straight or in a swirling configuration 640 (FIG. K). The projections and/or recesses can be long and continuous or they can be intermittent (see FIG. K). They can be inwardly dimpled or outwardly dimpled (see FIG. K). Another configuration has them ramped, as can be understood from FIGS. I and J at 660.

FIG. G is a top plan view of a second alternative bottom base and is similar to that of FIG. A but has radial ribs. These ribs can create additional turbulence in the liquid.

As shown in FIG. K, the “ribs” can have a “wave pattern.” A “ramp pattern” with each rib rising gradually then descending rapidly to the surface of the bottom base, is shown in FIGS. I and J at 660, to augment the vortex I tornado action of the rotating stir bar.

A further configuration has the bottom base configured with a center recessed floor and the base area around the recessed floor having an arched configuration from the outer perimeter to the recessed floor. This can be seen in FIG. F at 700, and can be compared with the configurations of FIGS. D and E, for example. This “arched” configuration consumes more volume so that the liquid is less likely to get “stuck” below the height of a (bottom mounted) spout because the arch consumes the volume inside the container that is beneath the height of the spigot. This configuration may be more effective to position the stir bar in the bottom because the sloping sidewalls and flat bottom will direct the stir bar through the sinking action of the stir bar due to the forces of gravity to the flat bottom that is centrally located above the motor/magnets.

The bottom base can include a large base to which the bottom floor of the recessed area is attached or is a part of to give the bottom base a larger stable support. As mentioned above, the base can include a recessed area and a base or ring portion(s) surrounding and supporting the recessed area. The recessed area can be formed separately from the base portion and then attached to it. Alternatively, it can be integrally formed such as in a molding procedure. The recessed area can be shaped as a flat ring. Alternatively, the area can be sloping towards the recessed area, or it can have a wavy shape. It can have radial and/or annular grooves or ridges. It can have inward or outward dimples. The shape can be selected to affect the mixing for differently configured/sized stir bars and/or containers or for different beverages. And/or the shape can be chosen to produce different and/or interesting tornadic effects.

The recessed area can have a diameter of between one and three inches and a depth of between 0.25 and two inches. The dimensions can be determined, for example by the size (diameter, height and/or volume) of the container, the anticipated contents of the container, and/or the anticipated viscosity (starting, interim and/or ending) of the contents.

An exemplary recessed area can have a diameter of between one and three inches, a depth of between 0.25 and two inches and a volume of between 0.19 and 14.3 cubic inches; and the container can have a diameter of approximately six inches. The diameter of the container can vary greatly, from one to twelve inches to massive industrial applications of twenty feet or more. The dimensions of the recessed area can change for different sizes of containers. An exemplary cylindrical container can be eighteen inches tall, six inches in diameter and have a volume of approximately seven liters. Units can be smaller and as an example a one liter container can be used for “shot” drinks or for more individualized “table service.” For large commercial applications one thousand gallon or larger containers can be used. For example, many micro brewers have vats on the premises which are twenty to fifty feet tall and ten to twenty feet in diameter. While an average size container for home/restaurant/bar use can be on the order of seven liters, the larger containers can be twenty to thirty liters. Containers larger than thirty liters may be too large to be supported on a bar or table and may require a larger installation and may even need to be floor mounted.

The base can include more than one magnetic stir bar, each in the same or separate recessed areas. The magnetic driver motor can be adapted as needed to rotate the multiple magnetic stir bars.

### Inlet

An interesting tornado effect can be created if food coloring or a different colored liquid (or particles) are injected or introduced into the container during the mixing process. They can be injected or introduced manually by the operator or user, or via an automatic means. They can be introduced through an inlet in the lid (or in the container wall). It may also be that the desired beverage mixes better if one of the ingredients (solid or liquid) is added during the mixing procedure, and an inlet may be needed for this in lieu of removing the lid.

### Multiple Turning Points

More than one stir bar can be provided, each in its own recessed area or spaced from one another in a large recessed area of the base plate in a singular/single container. This can create interesting mixing tornadic effects and/or more effectively mix larger containers.

There are some mixers that have multiple points, basically they create more than one single turning point for multiple stir bars. Another advantage of these would be to have a multiplicity of cavities providing for more than one single beverage dispenser/mixer (more than one beverage flavor selection) on a single motor assembly, instead of having multiple motor assemblies. The advantage of such a unit would be to utilize or present two or more beverage containers positioned on the same magnetic stirring/motor device. Specifically, one beverage unit would have just one color/flavor profile. Such a unit would allow the user to offer a multiple of beverage choices. An alternative is to construct the apparatus such that a plurality of containers can be placed on and mixed on a single motor apparatus. The motor apparatus can have multiple turning areas, each for a different container. Thus, a plurality of different beverages can be mixed, stored and available for dispensing at the same time.

The advantage of such a unit is to utilize I present two or more beverage containers positioned on the same magnetic stirring I motor device. Specifically, one beverage unit would have just one color I flavor profile. Such a unit would allow a multiple beverage choices to be offered.

According to another embodiment, a single drive motor unit can be used for multiple containers and/or multiple cavities in a singular container, each with its own base plate, recessed area and magnetic stir bar.

### Pin Alternative

Referring to FIGS. R and S, the base can be viewed as having two portions, namely a center portion and a ring portion surrounding the center portion. The center portion can include the recessed area including any retainers. Alternatively, the center portion can include a pivot post.

FIG. R is a perspective view of an alternative bottom base having a pivot pin 730 about which the stir bar 740 can spin and a retainer 750 at the top of the pin for maintaining the stir bar on the pin.

Instead of a pin, a post or stub can be provided secured to the bottom base. The stir bar can have an upside-down cup shape which fits over the stub. Stirring members extend up and/or out from the cup. The stub prevents horizontal movement of the stir bar.

### Cage Alternative

In lieu of a recessed area (with or without retention means) a “cage” can be used to keep the magnetic stir bar in place relative to the magnetic drive. The cage can be attached to a bottom floor or base of the container, such as in a central area. An example thereof is depicted in FIGS. T and U at 800. The cage can serve two purposes. One purpose is to keep the magnetic stir bar in operative position relative to the magnetic driver. It can keep it in position in the z direction, as well as the x and y directions. Another purpose is to allow the fluid in the container to communicate with the magnetic stir bar, so that the stir bar can efficiently stir the fluid, as it is rotated by the magnetic drive motor. The cage can provide this fluid communication in the z direction, such as by using a retention plate or grate. It also can provide it in the x and/or y directions. For example, the cage can have a cylindrical shape with the longitudinal axis being a vertical axis. The cylindrical shape can be circular, rectangular, hexagonal and so forth. The cylinder can be perforated wall(s) or grate(s). The magnetic stir bar can be accessed by removing the top base of the cage and/or by detaching the cage from the floor. The cage can be designed to address or restrict movement of the stir bar in only the x and y directions, such as by having an open top. Alternatively, the cage can be designed to address or restrict movement in only the z direction, such as by a “cage” design that engages the sides of the container or support structures to the base plate, which hold the cage about the base plate. The cage can preferably be circular in cross-section to correspond to the geometric region within which the stir bar will operate. The side wall can have openings to allow liquid to pass there through to promote mixing. On the other hand, the side wall can be free of openings, at least to the height of the stir bar, to avoid interference of the holes with the rotating stir bar.

### Periodic Stirring

The apparatus can have a periodic stirring function whereby stirring occurs periodically to keep the liquid (beverage) mixed as it may tend to settle. This can be a fixed function, programmed into the apparatus according to a preset program. Or the program can be adjustable or controllable by the user. For example, there can be a user input operatively connected to the motor in the motor assembly. The input can be positioned on the cover or holder or on the motor assembly. It can be a dial, a push button or other input. The input can be a selection between different fixed mixing programs. Or the input can be an input by the user of one or more factors from which the mixing program will be computed by the apparatus, such as via the CPU of the apparatus. The spinning may be done less often and/or for shorter periods of time as the liquid is dispensed from the container. This stirring programming can be used for mixers other than magnetic mixers. An alternative is to have the stir bar running constantly. It can run at a steady speed or at varying speeds. It can have an automatic turnoff, after a predetermined period of time has passed or after the liquid in the container has reached a predetermined low level or weight.

The apparatus can include various user inputs that may be in the form of knobs, dials, switches, LEDS or buttons and may be on the motor casing, the cover for the motor or on a remote control unit. These inputs can include on/off control, beverage type or viscosity, various motor speed settings, and light controls.

### Lights

The light controls are to control one or more lights for illuminating the liquid contents of the container. This can be helpful for the user to identify the amount and the type of contents. The one or more lights can also illuminate that liquid as it is moving within the container/apparatus, particularly with a tornado effect, to provide an attractive display. The one or more lights can have a different illumination pattern signaling that the stir bar is shimmering, skipping or whether the stir bar is off center. More than one type or color of light can be provided/selected and the user can alternatively select which one is to be used. Alternatively, the lights can be illuminated in on-off patterns; for example, a red light for ten seconds, then a blue light for fifteen seconds and then both lights for five seconds. The one or more lights can be operated in a strobe pattern. The illumination can be coordinated with the spinning liquid regimen; for example, a faster on-off pattern for a faster spinning (tornado) or a slower pattern for less liquid. A further, more exotic option is to coordinate the light(s) with music.

The one or more lights can be positioned on/at/in the container or above the unit/apparatus, for example, positioned in the lid. The one or more lights can be positioned in the base unit, inside the motor with a clear base bottom permitting the light to pass up through the bottom and into the unit/container. The one or more lights can be selected from lights that either will not admit heat such as LED lights or neon where room temperature or cooled beverages are preferred. It is also within the scope herein to use other lights such as incandescent lights.

A mixing regimen can include the magnetic stir bar spinning at a first fixed speed for a first period of time and then automatically at a second different fixed speed for a second period of time.

### Amount of Undissolved Particles

It is also within the scope of the present inventions to provide a detector, sensor or reader (such as an optical sensor) which determines the amount of and/or increase in sediment or undissolved particles in the container (for example, in the lower part of the container) or a comparison in different parts of the container and to adjust the speed of the stir bar. For example, if there is a large amount of undissolved particles in the lower part of the container the stir bar may be sped up.

### Data Input

As examples only, the user or operator may input data/information on one or more of the following:

1. The estimated viscosity/thickness of the liquid, for example, “thin” for iced tea and “thick” for a smoothie. There can be more than two settings. The designation can be a sample beverage, e.g., “iced tea, and/or a thickness designation, e.g., “moderately thick.”
2. How often the mixer is to be turned on.
3. Number of times the mixer is to be turned on.
4. Length of each mixing cycle.

The user input information or instructions can then be combined with one or more factors discerned/detected by the apparatus itself. For example:
1. Weight of liquid remaining in container, such as by a scale on/in the motor assembly or the holder or a bob sensor to determine the height of the remaining liquid.
2. Resistance to turning of stir bar.
3. Passage of time, measured by clock in the CPU for example.
4. Past programming history.
5. Viscosity of liquid.
6. Characteristics of tornado, as measured for example by motion sensors.
7. Amount of and/or increase in “sediment”/undissolved particles in lower part of container.

The scale can be positioned in the encasement for the moving parts or magnetic coils that make up the motor. The bob can be located in the container, the motor cover or the motor compartment. The data produced by the scale and/or bob can be fed into a CPU or controller to adjust the speed of the motor. Alternatively, the scale and/or bob can be positioned in the base plate of the container but preferably not in a position to interfere with the operation of the stir bar. The CPU can be positioned in the motor encasement or in the base plate of the container.

A scale can be provided in the motor or motor cover (or in the base of the container). The lesser weight or height the slower the rpm (or target rpm) due to less hydrostatic resistances on the stir magnet. A technology can also measure or detect the centipoise/viscosity of the liquid too (syrup like or frozen beverage like as opposed to water like).

### Motor Control

A number of factors can contribute to the relationship of the rotational speed of the motor to that of the stir bar. If the motor spins faster than the stir bar, the stir bar can skip or jump off center, causing the mixing action of the apparatus to stop.

A skipped stir bar will jump off center (where a physical restraint would be effective) and/or “freeze” (where the stir bar does not rotate but rather “shimmers” back and forth as the magnets in the motor pull/push the stir bar back and forth) where the stir bar is not able to generate a directional rotation and keep up with the speed of the motor.

This problem can be remedied using any of the retaining devices of this disclosure. However, the retaining devices may interfere with or at least partially block the desired agitation or mixing of the liquid by the stir bar.

The thicker (the more viscous) the liquid is and/or the more liquid in the container, the more likely the stir bar is to skip. The greater the volume of liquid in the container, the greater the hydrostatic resistance will be and the more likely the stir bar will skip. Further, the heavier the liquid (that is, the more dissolved solids, such as sugar that adds weight but not necessarily volume) the more likely the stir bar is to skip because the greater the mass that the stir bar has to push the more likely it is to skip. The more viscous the liquid (whether frozen or via the use of polysaccharides and food gums, for example) the more likely the stir bar will skip. Even further, the weaker the motor and the weaker the magnet in the stir bar, the more likely the stir bar will skip.

All of these variables work together to effect the operation of the stir bar and the mixing performance of the apparatus. This is why it is useful to “read” the position of the stir bar, and also to physically restrain the stir bar too, particularly if the position is not being read. That is, the operation of the stir bar will vary for different beverages due to their different viscosities and/or their differing amounts of dissolved solids (e.g., sugar) and/or viscosity of the liquid (e.g., frozen or food gums). The operation will also vary for different volumes of beverage in the container, which will decrease as a user withdraws beverage via the spigot into a drinking glass, cup or the like and which will increase as additional liquid is poured into the container via the open lid.

Stopping or avoiding “shimmering” can be done by operating the drive motor to increase the magnetic force of the magnets/coils in the motor and thereby causing a greater force to be exerted on the stir bar to move it to the desired position and/or by slowing the motor to allow more time for the magnetic stir bar to move to the desired position. The “desired position” is defined as the next electromagnetic coil in relation to the immediate position of the Stir Bar or in the instance where the motor is a rotating magnet the area of magnetization trailing the direction of the rotating magnet(s) of the motor. If slowing the motor alone does not move the stir bar, the drive motor can be operated to increase the force of the magnets on the stir bar.

Electronic or optical readers/sensors can detect the movement and position of the stir bar and these two variables can be adjusted automatically or manually. Examples of electronic or optical readers/sensors are made by Avago Technologies, Vishay, Di-soric, among other global suppliers, and they can be positioned under the base of the container about where the stir bar is located and/or in the motor area or motor cover.

One solution is to include a scale to measure the weight of the liquid in the container or the container plus the liquid therein. The weight and thereafter the reduction in weight of the liquid in the container can be determined. There is a direct correlation between the weight of the liquid and the hydrostatic drag or resistance on the stir bar, where “hydrostatic” relates to pressures that fluids exert or transmit.

A manual setting can be incorporated into the apparatus for different centipoise/viscosity settings, from a water-like liquid to an icy slush. The acceleration of the stir bar can be adjusted to be slower for higher viscosity liquids thereby allowing for the stir bar to reach the desired spinning speed and/or increasing the power of the motor magnets.

The rotating speed of the stir bar can be detected by an optical or magnetic reader of the apparatus. The detected or sensed stir bar speed can be compared to and checked against any given setting of the rotation speed of the motor. This data can be sent to a CPU which can then set and reset the speed of the magnetic motor until the speed of the stir bar reaches the desired velocity. Once the desired rotational velocity is reached, the CPU can continue to monitor the stir bar's spinning velocity, and thereafter adjust the speed of the motor and check and recheck the speed of the stir bar. Then the power of the magnets (force) in the motor and/or the speed of the motor can be adjusted.

In other words, the rotational velocity of the stir bar can be measured magnetically and/or optically. The power to the motor is adjusted to either accelerate the stir bar so that the desired velocity (Vset) equals the actual velocity (Va). For embodiments with a spigot, the volume of liquid in the container (as represented by either the height or weight of the liquid) is measured. Less liquid reduces the hydrostatic drag on the stir bar and the motor.

In other words, the speed of the motor can be controlled so that it runs at the speed at which the stir bar is rotating by measuring the rotational speed of the stir bar. Reference is hereby made to FIG. W.

### Weight, Volume and Viscosity of Liquid

Another embodiment of the invention is to control the speed of the motor so that it runs at a predetermined speed needed for the specific liquid in the container, taking into consideration the weight, volume and/or viscosity of the liquid. This can be done in a number of ways including the two discussed below.

One way is by measuring and or calculating the volume (weight of the liquid in the container) via: a) a weight scale in or under the base or motor cavity; and/or b) measuring the height of the liquid in the container, since the diameter of the container is already known, assuming a cylindrical shape or any shape for that matter. This makes the motor cover relevant to the size and shape of the container. Because if the motor cover has a predetermined shape (cylindrical) and diameter, once the height of the contents in the container has been measured, the volume is known (limited to good accuracy because the user could potentially use a container whose base shape is something other than ‘flat’ and or the container side walls could be something other than symmetrical). Alternatively if the base motor cover did not specify or limit the shape and size of the container, the dimensions (shape and sizes) can be input manually or automatically detected by a device in the base/motor/cover unit.

In other words, the speed of the motor can be controlled so that it runs at a predetermined speed by measuring and/or calculating the volume of the liquid. Reference is hereby made to FIG. X.

### Hydrostatic Drag on Stir Bar

Another way is by measuring the hydrostatic drag of the liquid on the stir bar. A computation can be made considering: a) the magnetic force being applied to the stir bar; b) the speed of the magnetic motor; c) less the frictional loss of the stir bar against base of the container; and d) the speed of the stir bar. The frictional loss of the stir bar against base of the container will change based on the size and shape of the stir bar and can either be predetermined by the manufacturer or selected from a list by the user or entered by the user.

In other words, the speed of the motor can be controlled so that it runs at a predetermined speed by measuring the hydrostatic drag and frictional losses of the liquid on the stir bar. Reference is hereby made to FIG. Y. An optical device for measuring the rotational speed of the stir bar can be located in the motor encasement, maybe centrally located, or in the side of the base plate of the container, but positioned so as to not interfere with the operation of the stir bar.

The viscosity of the liquid in the container can be determined by the speed and/or acceleration setting of the motor, the power of the motor and the velocity of the stir bar, taking into account the weight of the liquid in the container and the frictional loss of the stir bar.

Simply, the more viscous the liquid in the container the greater the hydrostatic drag on the stir bar, and the larger the drag, the more power (speed) the motor required from the motor to activate or rotate the stir bar. The volume of liquid in the container can be directly related to skipping. Generally, the more liquid in the container, the greater the drag on the stir bar and therefore the acceleration and speed of the motor should be reduced to prevent skipping until the stir bar has accelerated to the desired speed setting by the user. Accordingly, a measurement or calculation of the volume can be used to control the speed of the motor whereby it runs at a predetermined speed such that skipping is thereby prevented/minimized.

The hydrostatic drag of the liquid on the stir bar and the frictional losses from contact between the stir bar and the bottom of the container can be directly related to skipping. The hydrostatic drag is a calculation of the volume, weight and viscosity of the liquid, and the result of this calculation can be used to control both the acceleration and speed of the motor.

### Adding Ingredients

It may be desirable to add ingredients to the beverage after an initial mixing thereof, such as during the original preparation or after the original preparation of the beverage. For example, the unit may need to be refilled during normal operation or it may be decided after tasting an initial cup or two of the beverage that, for example, it needs more sugar, more liquor or an ingredient to make the beverage thicker or thinner. These can be added by removing the lid and adding the ingredients. Or it can be done through a smaller opening in the lid, which has advantages especially if done during the mixing procedure itself.

It may be that the user or operator will want to change the tornado effect during the mixing process, for example by adding a food coloring to the beverage or by adding particulate matter. These can be added through the above-mentioned opening. Provisions can be made so that one or more colorings are automatically added at different times. As an example, the user may add small dissolvable members to give the tornado a different effect. The user may operate the apparatus to adjust the operation of the stir bar during or before the mixing so as to change the tornado effect, or this adjustment can be done automatically.

The apparatus can have a continuous (or intermittent/periodic) stirring program with an automatic shutoff when the container is empty or nearly empty. The automatic shutoff can be provided by, actuated by or incorporated into a magnetic/electronic/light reader or a weight or volume detection sensor of the apparatus.

### Stir Bar Moving Up and Down

The cage or other retainer can be configured to allow the stir bar to hover and move along a vertical axis within the container so as to mix the liquid or medium at different vertical locations in the container so long as a portion of or an extension of the stir bar remains within the magnetic field of (the magnets in) the motor. This configuration may include an “extension” to drive the parts of the stir bar that cause the agitation in the container of the liquid. The stir bar can be moved in a predetermined motion, which may or may not depend on the characteristics of the liquid such as the liquid height, the mixing time elapsed, the viscosity. Or the stir bar can move in a free floating random motion. For example, if the retainer is a cage, as discussed above, it can have a configuration, such as a taper or a pattern of openings that become larger in one direction, to promote a specific motion. If the retainer is a central pin, as discussed above, the pin can have a taper. The motion can be varied by changing the rotation speed. The stir bar can have a propeller type configuration that pulls it upward along a drive shaft in the liquid as it spins faster. The drive motor can operate at varying speeds to move the stir bar up and down. The movement of the stir bar (up and down and/or rotational speed) can be made to correspond to music playing and/or different background lighting.

### Bottom Recessed Area

Providing the contoured base or bottom base of the container with a bottom recessed area can be desirable, even if there is no retaining plate. The recessed area receives and positions the stir bar when it sinks to the bottom of the container assuming that the recessed area is large enough to receive therein the entire stir bar, a width and length thereof and/or a significant bottom portion. The cover, positioner or recess of the motor assembly centers the container with respect to the motor and the recessed area centers the stir bar with respect to the container and thereby the motor.

### Kit can Include Stir Bars and Different Mixes

A kit of the present disclosure can include a number of stir bars for a single container. The stir bars can be all the same, and just be replacements for one another. Alternatively, two or more differently configured stir bars can be provided, allowing the user to select which one to use. The selection may depend on the properties of the beverage to be mixed. The stir bar may be selected, not only for more effective stirring, but also to provide a desired tornado effect. The kit can include different products to be mixed in the apparatus. These products can be packages of powdered mix or they can be concentrated liquids or liquids that are premixed and ready for immediate consumption. The kit can include stir bars specifically configured for each different product in the kit.

### Remarks

It should be understood that terminology used for orientation, such as front, rear, side, left and right, upper and lower, and the like, are used herein merely for ease of understanding and reference, and are not used as exclusive terms for the structures being described and illustrated. Having thus described several exemplary implementations, it will be apparent that various alterations and modifications can be made without departing from the concepts discussed herein. As an example only, the apparatus and methods can be adapted for fluids/liquids other than consumable beverages. Such alterations and modifications, though not expressly described above, are nonetheless intended and implied to be within the spirit and scope of the inventions. Accordingly, the foregoing description is intended to be illustrative only.

What is claimed is:

1. A magnetic mixer apparatus comprising:
a fluid container having a bottom base;
the bottom base having a recessed area;
a magnetic driver motor; and
a magnetic stir bar positioned generally in the recessed area and rotatable by the magnetic driver motor positioned beneath the stir bar.

2. The magnetic mixer apparatus of claim 1 wherein the container has a spigot.

3. The magnetic mixer apparatus of claim 1 wherein the container has a lid.

4. The magnetic mixer apparatus of claim 1 wherein the stir bar has a plus or cross shape and/or a shape including a plurality of fingers extending out from an axis.

5. The magnetic mixer apparatus of claim 1 wherein the container has a cylindrical or frusto-conical shape.

6. The magnetic mixer apparatus of claim 1 wherein the magnetic driver motor produces a rotating magnetic field that rotates the magnetic stir bar to thereby stir liquid in the container.

7. The magnetic mixer apparatus of claim 1 further comprising a base motor cover that positions the recessed area and thereby the magnetic stir bar in an operative position relative to the magnetic driver motor.

8. The magnetic mixer apparatus of claim 7 wherein the base motor cover has a top opening, and the recessed area extends down through the opening.

9. The magnetic mixer apparatus of claim 8 wherein the recessed area is adjacent a top surface of the magnetic driver motor.

10. The magnetic mixer apparatus of claim 8 wherein the recessed area engages and/or rests on a top surface of the magnetic driver motor.

11. The magnetic mixer apparatus of claim 7 wherein the base cover and the magnetic driver motor are separate and separable components.

12. The magnetic mixer apparatus of claim 1 wherein the recessed area has a diameter of between one and three inches, a depth of between 0.25 and two inches and a volume of between 0.19 and 14.3 cubic inches, and the container is between five and seven inches in diameter and has a height between 12 and 30 inches.

13. The magnetic mixer apparatus of claim 1 further comprising a holder that holds the container relative to the magnetic driver motor in an operative position to operatively rotate the stir bar in the recessed area.

14. The magnetic mixer apparatus of claim 1 wherein the portion of the bottom base surrounding the recessed area forms a ring.

15. The magnetic mixer apparatus of claim 14 wherein the ring is flat, slopes from the outer periphery towards the recessed area, has ridges, has grooves, is wavy, has one or more protrusions and/or has one or more recesses.

16. The magnetic mixer apparatus of claim 1 wherein the magnetic stir bar is generally free floating in a vertical direction in the recessed area in the fluid in the container during operation of the magnetic driver motor.

17. The magnetic mixer apparatus of claim 1 wherein the container has an upright cylindrical shape that is generally eighteen inches tall, is generally six inches in diameter and has a volume of generally seven liters.

18. A magnetic mixer apparatus comprising:
a fluid container having a bottom base;
the bottom base having a central recessed area; and
a rotatable magnetic stir bar positioned in the recessed area.

19. The magnetic mixer apparatus of claim 18 wherein the container is a generally rigid container that is free of any internal bag to hold the fluid in the container.

20. The magnetic mixer apparatus of claim 18 wherein the container includes a spigot.

21. The magnetic mixer apparatus of claim 18 further comprising a magnetic driver motor cover adapted to operatively position the recessed area and thereby the magnetic stir bar for a stirring action of liquid in the container.

22. The magnetic mixer apparatus of claim 21 wherein the cover has a top opening to receive the container, and the cover positions the bottom base on top of the motor with the container in position in the top opening.

23. The magnetic mixer apparatus of claim 18 further comprising retaining means for retaining the magnetic stir bar in the recessed area during a stirring operation while allowing liquid in the container to be mixed by the magnetic stir bar.

24. The magnetic mixer apparatus of claim 23 wherein the retaining means includes a base with liquid passage through-openings and positioned on top of the recessed area.

25. The magnetic mixer apparatus of claim 23 wherein the retaining means includes a grate positioned on top of the recessed area.

26. The magnetic mixer apparatus of claim 23 wherein the retaining means includes one or more inwardly bulging portions and/or one or more projecting members of the recessed area.

27. A magnetic mixer apparatus comprising:
a fluid container having a bottom base;
the bottom base having a recessed area;
a rotatable magnetic stir bar positioned in the recessed area;
a magnetic driver motor assembly for rotating the stir bar; and
the drive motor assembly having a positioning structure that operatively positions the recessed area and the stir bar therein.

28. The magnetic mixer apparatus of claim 27 wherein the positioning structure includes a well or recessed area on a top surface of the drive motor assembly for receiving a bottom portion of the container therein.

29. The magnetic mixer apparatus of claim 27 wherein the positioning structure includes a ring on a top surface of the drive motor assembly in which the recessed area is received such that the recessed area engages the top surface.

30. The magnetic mixer apparatus of claim 27 wherein the fluid container includes a spigot.

31. The magnetic mixer apparatus of claim 27 wherein the drive motor assembly includes a rotating magnet or a set of stationary electromagnets.

32. A magnetic mixer apparatus comprising:
a fluid container having a bottom base;
a rotatable magnetic stir bar; and
the bottom base including a mechanical retainer that retains the magnetic stir bar in an operative rotating position while providing stirring access of the stir bar to liquid/fluid in the container.

33. The magnetic mixer apparatus of claim 32 wherein the mechanical retainer includes a pivot pin about which the stir bar is rotatable.

34. The magnetic mixer apparatus of claim 33 wherein the mechanical retainer includes a holder that releasably holds the stir bar on the pivot pin.

35. The magnetic mixer apparatus of claim 32 wherein the container includes a spigot for withdrawing liquid from the container.

36. The magnetic mixer apparatus of claim 35 wherein the spigot is in an upper portion of the container and a pump delivers the liquid from a lower portion of the container up to the spigot.

37. The magnetic mixer apparatus of claim 32 wherein the mechanical retainer includes an upwardly-disposed cage in which the stir bar is positioned and held.

38. The magnetic mixer apparatus of claim 32 wherein the mechanical retainer includes a recessed area of the base in which the stir bar is positioned and one or more retainer members protruding into a top opening of the recessed area.

39. The magnetic mixer apparatus of claim 32 further comprising a positioning cover having a through-hole configured to receive the container therein to operatively position the stir bar relative to a magnetic driver motor.

40. The magnetic mixer apparatus of claim 32 further comprising a magnetic driver motor having an upper recess configured to receive a lower end of the container and thereby to operatively position the stir bar.

41. The magnetic mixer apparatus of claim 32 wherein the container is a generally rigid container that is free of any internal bag to hold the fluid/liquid.

42. A magnetic mixer apparatus comprising:
a fluid container having a bottom base;
a magnetic driver motor;
a magnetic stir bar positioned in the container at the bottom base and rotatable by the magnetic driver motor positioned beneath the stir bar to stir fluid in the container;
a user input mechanism; and
a controller for at least in part controlling the operation of the magnetic driver motor among different stirring programs using at least in part input from the user input mechanism.

43. The magnetic mixer apparatus of claim 42 further comprising one or more sensors that detect information concerning one or more properties or conditions of the magnetic stir bar and/or the fluid in the container and transmitting the information to the controller to at least in part control the operation of the magnetic driver motor.

44. The magnetic mixer apparatus of claim 43 wherein the information includes the weight of fluid in the container, the volume of liquid in the container and/or the rotational speed of the stir bar.

45. The magnetic mixer apparatus of claim 42 wherein the user input mechanism is adapted for input of user information regarding the viscosity of the fluid, the length of the mixing cycle, and/or the frequency of the mixing cycle.

46. The magnetic mixer apparatus of claim 42 wherein the user input mechanism includes a button, switch, knob, toggle and/or dial.

47. A magnetic mixer apparatus comprising:
a magnetic mixer drive motor;
a generally rigid container that is free of any flexible bags to contain liquid;
a spigot adapted to dispense mixed beverage from the container;
a magnetic stir bar in the container; and
preventing means for preventing the stir bar from skipping out of position and thereby retaining the stir bar in an operative position relative to the drive motor and to the liquid in the container.

48. The magnetic mixer apparatus of claim 47 further comprising positioning means for positioning the container such that the stir bar is in an operative position relative to the drive motor;

49. The magnetic mixer apparatus of claim 48 wherein the positioning means includes a sleeve.

50. The magnetic mixer apparatus of claim 49 wherein the sleeve is a separate and separable component from the drive motor.

51. The magnetic mixer apparatus of claim 49 wherein the sleeve is an integral part of a casing of the drive motor.

52. The magnetic mixer apparatus of claim 47 wherein the preventing means includes mechanical structure connected to, removable from or part of a base plate of the container.

53. The magnetic mixer apparatus of claim 48 wherein the preventing means includes (optical or magnetic) electronics configured to control the speed of the drive motor relative to that of the magnetic stir bar.

54. A magnetic mixer apparatus comprising:
a magnetic mixer drive motor;
a generally rigid container that is free of any flexible bags to contain liquid;
the fluid container having a bottom base that has a recessed area;
a spigot adapted to dispense mixed beverage from the container; and
a magnetic stir bar positioned generally in the recessed area.

55. A magnetic mixer apparatus comprising:
a fluid container;
a magnetic driver motor;
a magnetic stir bar positioned in the container and rotatable by the magnetic driver motor positioned beneath the stir bar to stir liquid/fluid in the container; and
controlling means for controlling the operation of the motor so that the motor speed does not exceed the speed of the stir bar and thereby cause the stir bar to move out of position.

56. The magnetic mixer apparatus of claim 55 wherein the fluid container includes a generally rigid container that is free of any internal bag to hold the fluid in the container, and the container includes a spigot for dispensing fluid.

57. The magnetic mixer apparatus of claim 55 wherein the controlling means includes measuring the speed of the stir bar and/or properties of the liquid.

58. A method comprising:
using a magnetic drive motor, rotating a magnetic stir bar in a container having liquid therein; and
adjusting the speed of the magnetic drive motor so that the motor runs at the desired rotational speed of the magnetic stir bar.

59. The method of claim 56 wherein the adjusting the speed includes measuring the speed of the magnetic stir bar.

60. The method of claim 59 wherein the measuring uses a magnetic or optical sensor.

61. A method comprising:
using a magnetic drive motor, rotating a magnetic stir bar in a container having liquid therein; and
using a spigot to withdraw mixed contents of the liquid from the container.

62. The method of claim 61 wherein a base of the container is contoured with a recessed area to position the stir bar in the base.

63. The method of claim 62 wherein the recessed area has a retention mechanism that is a physical barrier to restrain the stir bar or an electronic, magnetic or optical measuring feature to control the actions of the motor relative to the stir bar.

64. A method comprising:
using a magnetic drive motor, rotating a magnetic stir bar in a container having liquid therein; and
adjusting the speed of the magnetic drive motor so that the motor runs at a predetermined speed, the adjusting includes measuring and/or calculating the volume or weight of liquid in the container.

65. The method of claim 64 wherein the measuring and/or calculating the volume includes using a weight scale within an encasement of the motor, a cover of the motor or base of the container and/or calculating the volume using a floating bob that rises as contents are added to the container and falls as contents are withdrawn, such as via a spigot.

66. A method comprising:
using a magnetic drive motor,
rotating a magnetic stir bar in a container having liquid therein; and
adjusting the speed of the magnetic drive motor so that the motor runs at a predetermined speed by measuring and/or calculating the hydrostatic drag and/or frictional losses of the liquid on the stir bar.

67. The method of claim 66 wherein the measuring and/or calculating includes measuring and/or calculating the volume, weight and viscosity of the liquid.

68. The method of claim 66 wherein the calculating the hydrostatic drag includes using the volume, weight and viscosity in the following equation or relationship:
Fd=−˜6pACd(v.v)(v/llvll), where
Fd is the force vector of drag,
p is the density of the fluid,
v is the velocity of the object relative to the fluid,
A is the reference area, and
Cd is the drag coefficient.

69. A method comprising:
causing a magnetic drive motor that receives a shimmering signal noting that a magnetic stir bar is shimmering instead of spinning to slow to allow more time for the magnetic stir bar to move to a desired position and/or increases the magnetic force of magnets/coils in the motor such that the motor exerts a greater magnetic force on the stir bar to the desired position.

70. The method of claim 69 wherein the shimmering signal is received from an optical, magnetic or electronic sensor.

71. The method of claim 69 wherein the shimmering signal is initiated by a user.

72. The method of claim 69 wherein the causing includes increasing the magnetic force of the drive motor on the stir bar to move the stir bar to the desired position and/or by slowing the motor to allow more time for the stir bar to move to the desired position.

73. A magnetic mixer apparatus comprising:
a magnetic drive motor having either one or more magnets or electromagnets and capable of generating a magnetic drive field that can rotate a magnetic stir bar in a container of liquid; and
the motor having a controller that when the controller receives a shimmering signal noting that the magnetic stir bar is shimmering instead of spinning causes the motor to slow to allow more time for the magnetic stir bar to move to a desired position and/or increases the magnetic force of the magnets/coils in the motor and thereby exerting a greater magnetic force on the stir bar to the desired position.

74. The magnetic mixer apparatus of claim 73 further comprising an optical, magnetic or electronic sensor that can sense when the magnetic stir bar is shimmering and send the shimmering signal to the controller.

75. The magnetic mixer apparatus of claim 73 further comprising a user input mechanism via which a user can cause the shimmering signal to be sent to the controller.

76. The magnetic mixer apparatus of claim 73 wherein the controller includes a CPU.
